(19) United States
(12) Patent Application Publication
(10) Pub. No.: US 2013/0096969 A1
(43) Pub. Date: Apr. 18, 2013

(54) METHOD FOR ENHANCING TRANSIT SCHEDULE

(71) Applicant: Christos Karanicolas, Massapequa Park, NY (US)

(72) Inventor: Christos Karanicolas, Massapequa Park, NY (US)

(21) Appl. No.: 13/704,915

(22) PCT Filed: Jun. 17, 2011
(86) PCT No.: PCT/US11/40897

§ 371 Date: Dec. 17, 2012

(51) Int. Cl. G06Q 50/30

(52) U.S. Cl. CPC G06Q 50/30; G06Q 10/06311
USPC 705/7.13

(57) ABSTRACT

A method and apparatus are provided for generating an enhanced transit schedule. Schedule deviations are calculated using an existing transit schedule. The schedule deviations are grouped in accordance with a plurality of schedule parameters. A group average deviation is computed for each group of schedule deviations. Each group average deviation is applied to a corresponding set of passing times of the existing transit schedule having corresponding schedule parameters to generate the enhanced transit schedule.

### PRIORITY

This application claims priority under 35 U.S.C. §119(e) to U.S. Provisional Patent Application Nos. 61/355,866 and 61/377,565 filed on Jun. 17, 2010 and Aug. 27, 2010, respectively, the disclosures of which are incorporated herein by reference.

### BACKGROUND OF THE INVENTION

1. Field of the Invention

The present invention relates generally to the enhancement of a transit schedule, and more particularly, to a method for generating an enhanced transit schedule using an existing transit schedule and a history of variance.

2. Description of the Related Art

Public transit is a part of every-day life in many parts of the world and, in particular, urban environments. Commuters rely on transit schedules to plan their trips. Most commuters rely on published, existing, predetermined transit schedules, which do not take into account conditions that may affect the transit schedule such as road work, weather, transit system repair work, street closures, vehicle malfunctions, strikes, and the like. For this reason, such published, static, transit schedules may be considered unreliable.

Attempts that have been made to remedy the above problem include systems for notifying passengers waiting for public transit vehicles of the status of the vehicles, including the arrival times of vehicles at stops. Such systems may work using Global Positioning System (GPS) devices installed on the public transit vehicles. The transit vehicles contain communications devices to relay estimated arrival times to customers waiting at bus stops and the like.

Methods of estimating arrival times can be based on various metrics such as time, date, historical statistics, average speed, current weather, weather forecasts, current traffic and traffic forecasts.

### SUMMARY OF THE INVENTION

The present invention has been made to address at least the above problems and/or disadvantages and to provide at least the advantages described below. Accordingly, an aspect of the present invention provides a method for generating an enhanced transit schedule using an existing transit schedule and a history of variance from that transit schedule.

According to one aspect of the present invention, a method is provided for generating an enhanced transit schedule. Schedule deviations are calculated using an existing transit schedule. The schedule deviations are grouped in accordance with a plurality of schedule parameters. A group average deviation is computed for each group of schedule deviations. Each group average deviation is applied to a corresponding set of passing times of the existing transit schedule having corresponding schedule parameters to generate the enhanced transit schedule.

According to another aspect of the present invention, an apparatus for generating an enhanced transit schedule is provided. The apparatus includes a user input device, and a memory for storing an existing transit schedule and schedule deviations. The apparatus also includes a processor for calculating schedule deviations using the existing transit schedule, grouping the schedule deviations in accordance with a plurality of schedule parameters, computing a group average deviation for each group of schedule deviations, and applying each group average deviation to a corresponding set of passing times of the existing transit schedule having corresponding schedule parameters to generate the enhanced transit schedule. The apparatus further includes a display for displaying at least a portion of the enhanced transit schedule.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a flowchart illustrating a method of generating an enhanced transit schedule, according to an embodiment of the present invention;

FIG. 2 is a flowchart illustrating the calculation of schedule deviations using an existing transit schedule, according to an embodiment of the present invention;

FIG. 3 is a flowchart illustrating the computation of a group average deviation for each group of schedule deviations, according to an embodiment of the present invention;

FIG. 4 is a graph illustrating a sample exponential moving average weight distribution;

FIG. 5 is a flowchart illustrating the application of each group average deviation to a set of passing times of the existing transit schedule, according to an embodiment of the present invention; and

FIG. 6 is a block diagram illustrating a system for generating an enhanced transit schedule, according to an embodiment of the present invention.

### DETAILED DESCRIPTION OF EMBODIMENTS OF THE PRESENT INVENTION

Preferred embodiments of the present invention are described in detail with reference to the accompanying drawings. Detailed descriptions of constructions or processes known in the art may be omitted to avoid obscuring the subject matter of the present invention. Further, in the following description of the present invention, various specific definitions found in the following description are provided only to provide a general understanding of the present invention, and it is apparent to those skilled in the art that the present invention can be implemented without such definitions.

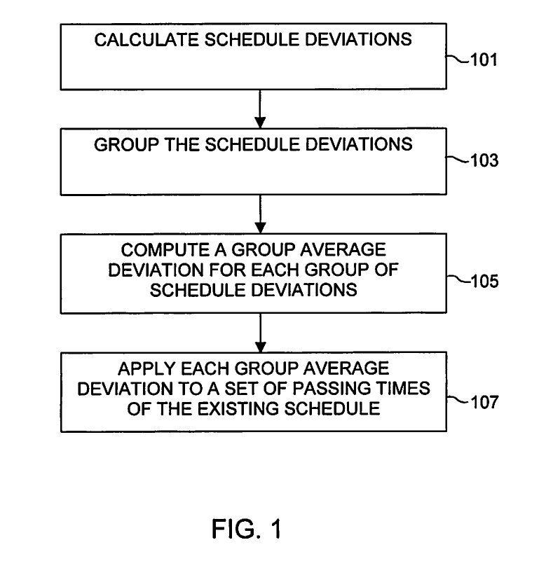

Referring initially to FIG. 1, a flowchart illustrates a method of generating an enhanced transit schedule, according to an embodiment of the present invention. Schedule deviations are calculated using an existing transit schedule in step 101. In an embodiment of the present invention, the existing transit schedule is received from a transit authority. A table of existing transit schedule deviations is shown below in Table 1.

TABLE 1

| | | | | | | On-time | | Early | | |
|---|---|---|---|---|---|---|---|---|---|---|
| | | | | | On- | Avg. | | Avg. | | Late Avg. |
| | | | | | time | Deviation | Early | Deviation | Late | Deviation |
| Date | Hour | Route | Direction | Stop | Count | (s) | Count | (s) | Count | (s) |
| Aug. 2, 2010 | 13 | 20 | Westbound | 456 | 6 | 45 | 3 | −134 | 6 | 356 |
| Aug. 2, 2010 | 14 | 20 | Westbound | 456 | 12 | 120 | 1 | −65 | 0 | 0 |
| Aug. 2, 2010 | 15 | 20 | Westbound | 456 | 10 | 64 | 0 | 0 | 2 | 432 |
| Aug. 2, 2010 | 16 | 20 | Westbound | 456 | 5 | 64 | 5 | −123 | 2 | 385 |
| Aug. 2, 2010 | 17 | 20 | Westbound | 456 | 10 | 105 | 0 | 0 | 2 | 405 |

The schedule deviations are grouped in accordance with a plurality of schedule parameters in step 103. In an embodiment of the present invention, the plurality of schedule parameters includes one or more of a route number, a direction, a stop and a specific time interval. The time interval may be a specific hour of the day. A grouped set of schedule deviations for hour 13 (i.e., between 1:00:00 p.m. and 1:59:59 p.m.), route 20, westbound direction and stop 456 is provided in Table 2 below.

TABLE 2

| | | | | | | On-time | | Early | | |
|---|---|---|---|---|---|---|---|---|---|---|
| | | | | | On- | Avg. | | Avg. | | Late Avg. |
| | | | | | time | Deviation | Early | Deviation | Late | Deviation |
| Date | Hour | Route | Direction | Stop | Count | (s) | Count | (s) | Count | (s) |
| Jul. 3, 2010 | 13 | 20 | Westbound | 456 | 6 | +45 | 3 | −134 | 6 | +356 |
| Jul. 10, 2010 | 13 | 20 | Westbound | 456 | 12 | +120 | 1 | −65 | 0 | 0 |
| Jul. 17, 2010 | 13 | 20 | Westbound | 456 | 10 | +64 | 0 | 0 | 2 | +432 |
| Jul. 24, 2010 | 13 | 20 | Westbound | 456 | 5 | +64 | 5 | −123 | 2 | +385 |
| Jul. 31, 2010 | 13 | 20 | Westbound | 456 | 10 | +105 | 0 | 0 | 2 | +405 |

In an embodiment of the present invention, schedule adherence data for a predetermined number of weekdays is selected when the current transit day begins on a weekday, schedule adherence data for a predetermined number of Saturdays is selected when the current transit day begins on a Saturday, and schedule adherence data for a predetermined number of Sundays is selected when the current transit day begins on a Sunday or a holiday.

Referring again to FIG. 1, group average deviation for each group of schedule deviations is computed in step 105. Each group average deviation is applied to a set of passing times of the existing transit schedule having schedule parameters for a corresponding group of the given group average deviation, to generate the enhanced transit schedule in step 107. The enhanced transit schedule may then be accessed by a user for transmission or display.

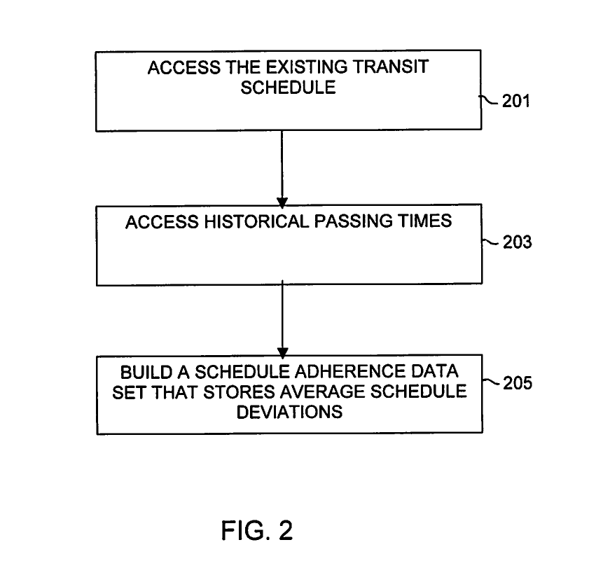

Referring to FIG. 2, a flowchart illustrates the calculation of schedule deviations using an existing transit schedule, according to an embodiment of the present invention. Specifically, FIG. 2 is a detailed description of step 101 in FIG. 1. In step 201, the existing transit schedule is accessed. The existing transit schedule may be a train or a bus schedule, for example. In step 203, historical passing times are accessed. Passing times are times when a stop or other point of interest is passed, or stopped at, by a public transit vehicle. In step 205, a schedule adherence data set that stores average schedule deviations for every route and stop combination is constructed using the existing transit schedule and the historical passing times. In an embodiment of the present invention, the historical passing times are collected by an application in real-time.

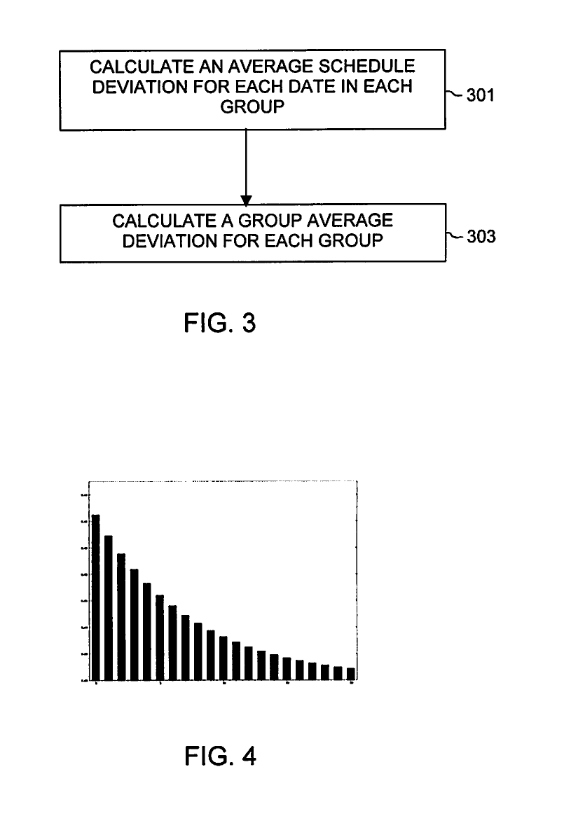

Referring to FIG. 3, a flowchart illustrates the computation of a group average deviation for each group of schedule deviations, according to an embodiment of the present invention. In step 301, an average schedule deviation is calculated for each date in each group (hour 13, route 20, westbound direction, stop 456), as illustrated in Table 3 below.

TABLE 3

| | | | | | | Total |
|---|---|---|---|---|---|---|
| | | | | | | Average |
| | | | | | Total | Schedule |
| Date | Hour | Route | Direction | Stop | Count | Deviation (s) |
| Jul. 3, 2010 | 13 | 20 | Westbound | 456 | 6 | +134 |
| Jul. 10, 2010 | 13 | 20 | Westbound | 456 | 12 | +106 |
| Jul. 17, 2010 | 13 | 20 | Westbound | 456 | 10 | +125 |
| Jul. 24, 2010 | 13 | 20 | Westbound | 456 | 5 | +40 |
| Jul. 31, 2010 | 13 | 20 | Westbound | 456 | 10 | +155 |

In step 303, a group average deviation is calculated by exponentially weighting the average schedule deviations for each date in that group. A graph illustrating a sample exponential moving average weight distribution is illustrated in FIG. 4. The exponentially weighted average deviation for the group of relevant deviations is calculated to be +65 seconds (i.e., 65 seconds late), as shown in Table 4. In an embodiment of the present invention, the smoothing factor of the exponentially weighted average is a number substantially close to 1. In another embodiment of the present invention, the exponentially weighted average gives more weight to the more recent data.

TABLE 4

| | | | | Exponential |
|---|---|---|---|---|
| | | | | Weighted Average |
| Hour | Route | Direction | Stop | Deviation (s) |
| 13 | 20 | Westbound | 456 | +65 |

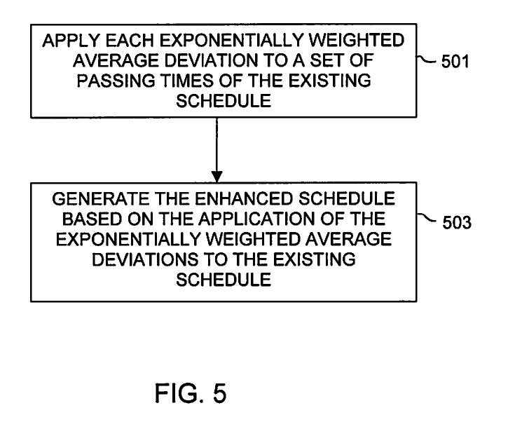

Referring now to FIG. 5, a flowchart illustrates the application of each group average deviation to a set of passing times of the existing transit schedule, according to an embodiment of the present invention. In step 501, an exponentially weighted average deviation, as shown in Table 4, is applied to a set of passing times of the existing transit schedule having corresponding hour, route, direction and stop parameters. Thus, as shown in Table 5 below, the calculated exponential average schedule deviation of 65 seconds is applied to the corresponding passing times of the existing transit schedule for the calculation of enhanced scheduled passing times. In step 503, an enhanced transit schedule is generated based on the application of each of a plurality of exponentially weighted average deviations to a corresponding set of passing times of the existing transit schedule.

TABLE 5

| | | | | Exponential | Enhanced |
|---|---|---|---|---|---|
| | | | | Average | Scheduled |
| | | | Scheduled | Schedule | Passing |
| Route | Direction | Stop | Passing Time | Deviation (s) | Time |
| 20 | Westbound | 456 | 1:00:28 PM | +65 | 1:01:33 PM |
| 20 | Westbound | 456 | 1:13:28 PM | +65 | 1:14:33 PM |
| 20 | Westbound | 456 | 1:26:53 PM | +65 | 1:27:58 PM |
| 20 | Westbound | 456 | 1:40:17 PM | +65 | 1:41:23 PM |
| 20 | Westbound | 456 | 1:53:17 PM | +65 | 1:54:23 PM |

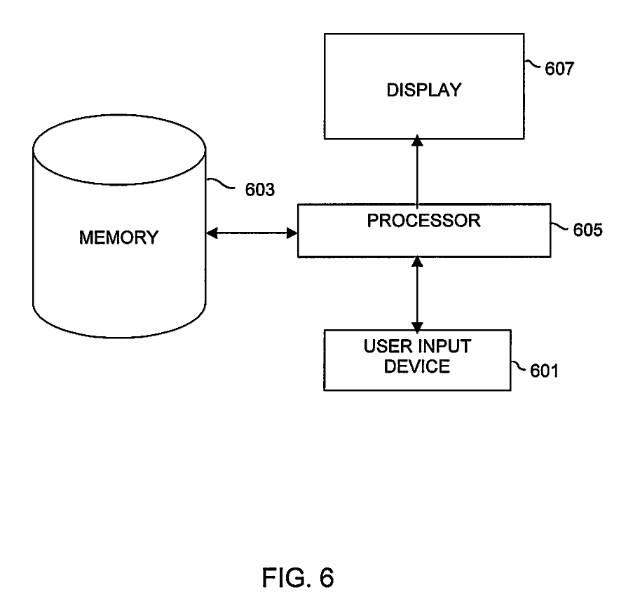

FIG. 6 illustrates an apparatus for generating an enhanced transit schedule, according to an embodiment of the present invention. The apparatus includes a user input device 607 for input of a plurality of schedule parameters, and a memory 503 for storing an existing transit schedule and schedule deviations. The apparatus also includes a processor 505 for calculating schedule deviations using an existing transit schedule, grouping the schedule deviations in accordance with a plurality of schedule parameters, computing a group average deviation for each group of schedule deviations, and applying each group average deviation to a corresponding set of passing times of the existing transit schedule to generate the enhanced transit schedule, as described above. Additionally, the apparatus includes a display 501 for displaying at least a portion of an enhanced transit schedule.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method for generating an enhanced transit schedule, the method comprising the steps of:
calculating schedule deviations using an existing transit schedule;
grouping the schedule deviations in accordance with a plurality of schedule parameters;
computing a group average deviation for each group of schedule deviations;
applying each group average deviation to a corresponding set of passing times of the existing transit schedule having corresponding schedule parameters to generate the enhanced transit schedule; and
outputting one or more elements of the enhanced transit schedule to a display.

2. The method of claim 1, wherein calculating schedule deviations comprises:
accessing the existing transit schedule;
accessing historical passing times;
compiling a schedule adherence data set that stores average schedule deviations for every route, stop and direction combination using the existing transit schedule and the historical passing times.

3. The method of claim 1, wherein computing the group average deviation comprises:
calculating an average schedule deviation for each date in each group; and
calculating the group average deviation for each group by exponentially weighting the average schedule deviations for each date.

4. The method of claim 3, wherein applying each group average deviation comprises:
applying each exponentially weighted average deviation to a corresponding set of passing times of the existing transit schedule having a corresponding time interval, route, direction and stop; and
generating the enhanced transit schedule based on the application of the exponentially weighted average deviations to the existing transit schedule.

5. The method of claim 1, wherein the plurality of schedule parameters comprise one or more of route, direction, stop and time interval.

6. The method of claim 5 wherein the time interval is an hour.

7. The method of claim 2, wherein the historical passing times are collected by an application in real-time.

8. The method of claim 1, wherein grouping the schedule deviations comprises:
grouping schedule adherence data for a predetermined number of weekdays, when a current transit day begins on a weekday;
grouping schedule adherence data for a predetermined number of Saturdays, when the current transit day begins on a Saturday; and
grouping schedule adherence data for a predetermined number of Sundays, when the current transit day begins on a Sunday or a holiday.

9. The method of claim 1, wherein the existing transit schedule is received from a transit authority.

10. The method of claim 3, wherein a smoothing factor of an exponentially weighted average is a number substantially close to 1.

11. The method of claim 3, wherein an exponentially weighted average gives more weight to more recent data.

12. An apparatus for generating an enhanced transit schedule, comprising:
a user input device;
a memory for storing an existing transit schedule and schedule deviations;
a processor for calculating schedule deviations using the existing transit schedule, grouping the schedule deviations in accordance with a plurality of schedule parameters, computing a group average deviation for each group of schedule deviations, and applying each group average deviation to a corresponding set of passing times of the existing transit schedule having corresponding schedule parameters to generate the enhanced transit schedule; and
a display for displaying at least a portion of the enhanced transit schedule.

13. The apparatus of claim 12, wherein the processor calculates the schedule deviations by accessing the existing transit schedule, accessing historical passing times, and compiling a schedule adherence data set that stores average schedule deviations for every route, stop and direction combination using the existing transit schedule and the historical passing times.

14. The apparatus of claim 12, wherein the processor computes the group average deviation by calculating an average schedule deviation for each date in each group, and calculating the group average deviation for each group by exponentially weighting the average schedule deviations for each date.

15. The apparatus of claim 14, wherein the processor applies each group average deviation by applying each exponentially weighted average deviation to a corresponding set of passing times of the existing transit schedule having a corresponding time interval, route, direction and stop, and generating the enhanced transit schedule based on the application of the exponentially weighted average deviations to the existing transit schedule.

16. The apparatus of claim 12, wherein the plurality of schedule parameters comprise one or more of route, direction, stop and time interval, and the time interval is an hour.

17. The method of claim 13, wherein the historical passing times are collected by an application in real-time.

18. The method of claim 12, wherein the processor groups the schedule deviations by grouping schedule adherence data for a predetermined number of weekdays, when a current transit day begins on a weekday, grouping schedule adherence data for a predetermined number of Saturdays, when the current transit day begins on a Saturday, and grouping schedule adherence data for a predetermined number of Sundays, when the current transit day begins on a Sunday or a holiday.

19. The method of claim 14, wherein a smoothing factor of an exponentially weighted average is a number substantially close to 1.

20. The method of claim 14, wherein an exponentially weighted average gives more weight to more recent data.
